(19) United States
(12) Patent Application Publication
(10) Pub. No.: US 2003/0039861 A1
(43) Pub. Date: Feb. 27, 2003

(54) Magnetic recording medium

(76) Inventor: Koji Naoe, Kanagawa (JP)

Correspondence Address: Matthew W. Siegal, Stroock & Stroock & Lavan LLP, 180 Maiden Lane, New York, NY, 10038, US

(21) Appl. No.: 10/081,458

(22) Filed: Feb. 21, 2002

(30) Foreign Application Priority Data
Feb. 22, 2001 (JP) 2001-046641

(51) Int. Cl. G11B 5/738

(52) U.S. Cl. 428/694 BS

(57) ABSTRACT

Provided is a magnetic recording medium suitable for a magnetic recording with high recording density. The magnetic recording medium comprises a nonmagnetic layer comprising a nonmagnetic powder and a binder and a magnetic layer comprising a ferromagnetic powder and a binder on a flexible nonmagnetic support in this order. The above nonmagnetic powder having a major axis length ranging from 0.04 to 0.2 μm, a minor axis length equal to or less than 0.04 μm and an acicular ratio equal to or higher than 2 and having a shape in which two or more acicular particles align in almost parallel.

### FIELD OF THE INVENTION

The present invention relates to a magnetic recording medium exhibiting high C/N ratio in high density recording.

### BACKGROUND OF THE INVENTION

In recent years, recording wavelengths have tended to shorten as recording densities have increased. However, the problem of self-magnetization loss where output drops when recording with a short wavelength on a thick magnetic layer has become significant. Thus, the magnetic layer has been reduced in thickness. However, in particulate magnetic recording media, when a magnetic layer equal to or less than 2 μm in thickness is directly coated onto a support, the nonmagnetic support tends to affect the surface of the magnetic layer. As a result, deterioration of electromagnetic characteristics and dropout tend to appear.

This problem is solved by a method employing a simultaneous multilayer coating method in which a nonmagnetic layer is provided as a lower layer and magnetic coating liquid with high concentration is thinly applied (for example, see Japanese Unexamined Patent Publication (KOKAI) Showa Nos. 63-191315 and 63-187418). Such inventions have made it possible to achieve good electromagnetic characteristics with dramatically improved yields. However, in recent popular digital VCR systems and the like, the need to further reduce medium noise in particulate media has emerged.

In popular digital VCR systems, a surface roughness with a wavelength pitch of about 4 μm is known to affect medium noise. However, in popular digital VCR system tapes, due to high output and O/W suitability requirements, as disclosed in Japanese Unexamined Patent Publication (KOKAI) Heisei No. 11-185240, the thickness of magnetic layer is reduced to about 0.1 μm . With this thinning of the magnetic layer comes a lessening of the effects caused by the magnetic layer (for example, aggregation of magnetic material and orientation irregularity on the surface characteristics of the magnetic layer), with the surface characteristics of the lower nonmagnetic layer almost entirely determining the surface characteristics of the magnetic layer. As means of smoothing the surface characteristics of the lower nonmagnetic layer, Japanese Unexamined Patent Publication (KOKAI) Heisei No. 4-325915 describes a method of employing acicular particles in the lower layer nonmagnetic powder and Japanese Patent No. 2698770 describes the use of flakes and plate-shaped particles as lower layer nonmagnetic powders. However, when the lower layer is thinned to about 0.1 to 0.5 μm, the surface is smooth, but calender forming properties decrease and the effects of base surface protrusions, aggregates in the upper/lower layers, and additives such as abrasives appear. In addition, output decreases and noise increases due to increasing protrusions on the magnetic layer surface.

Further, systems have recently been proposed in which the reproduction heads have been changed from inductive heads to MR heads to achieve high sensitivity and in which device noise around the head has been reduced to achieve high density. With high sensitivity achieved by the use of MR heads has come the need to further reduce the noise of the medium. However, due to the manufacturing methods employed, particulate media have rougher magnetic layer surfaces, and in particular, a greater surface roughness component with a pitch of several μm to several tens of μm as mentioned above than vacuum produced films (sputtering, CVD, vapor deposition). There is also a problem in the form of large variation in magnetic layer thickness resulting in modulation noise (DC magnetization noise).

Accordingly, an object of the present invention is to provide a particulate magnetic recording medium exhibiting high C/N in high density recording.

### SUMMARY OF THE INVENTION

The present inventors conducted extensive research into the above-stated requirements, resulting in the discovery of a particulate medium with low modulation noise and a small surface roughness component of several μm to several tens of μm in the form of the magnetic recording medium set forth below.

That is, the present invention relates to a magnetic recording medium comprising a nonmagnetic layer comprising a nonmagnetic powder and a binder and a magnetic layer comprising a ferromagnetic powder and a binder on a flexible nonmagnetic support in this order,

wherein said nonmagnetic powder is a clustered tabular nonmagnetic powder having a major axis length ranging from 0.04 to 0.2 μm, a minor axis length equal to or less than 0.04 μm and an acicular ratio equal to or higher than 2 and having a shape in which two or more acicular particles align in almost parallel.

In the above-mentioned magnetic recording medium, it is preferable that the magnetic layer is equal to or less than 0.2 μm in thickness and the ratio of the thickness of magnetic layer to the thickness of nonmagnetic layer (the thickness of magnetic layer/the thickness of nonmagnetic layer) ranges from 0.02 to 0.5.

### BRIEF DESCRIPTION OF THE FIGURES

FIG. 1 is a transmission electron microscope (TEM) photograph (1 μm/10 cm) of the clustered tabular nonmagnetic powder (powder C) comprising α-iron oxide employed in the embodiments.

FIG. 2 is a transmission electron microscope (TEM) photograph (1 μm/10 cm) of the acicular nonmagnetic powder (powder A) comprising α-iron oxide employed in Comparative Example 2.

### DETAILED EXPLANATION OF THE INVENTION

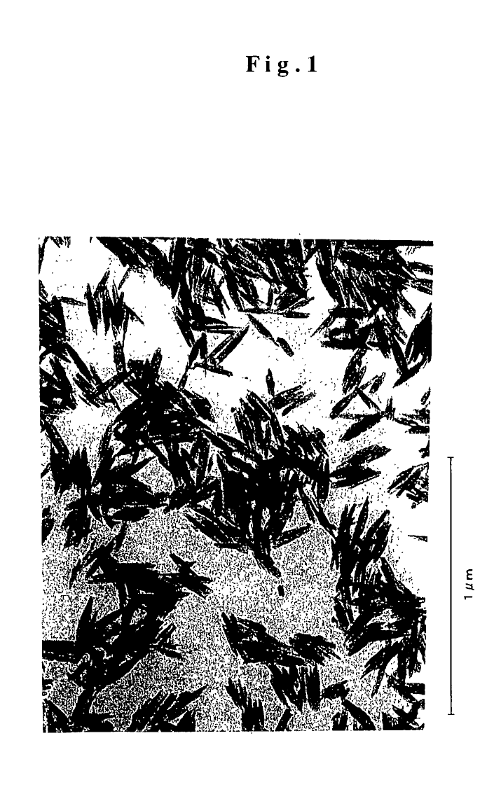

The magnetic recording medium of the present invention is characterized in that the nonmagnetic layer comprises clustered tabular nonmagnetic powder. The clustered tabular nonmagnetic powder has a shape in which two or more, preferably 2 to 5, acicular particles are linked together with the individual acicular particles being nearly parallel. The lengthwise sides of the acicular particles are bonded together. The acicular particles can also be viewed as having a shape where plural acicular particles are bundled into a raftlike shape, or a shape such as a bamboo leaf with one or two slits formed in each end. FIG. 1 shows an example of clustered tabular nonmagnetic powder. FIG. 1 is a transmission electron microscope (TEM) photograph (1 μm/10 cm) of clustered tabular nonmagnetic powder comprised of the α-iron oxide employed in the embodiments described further below.

The clustered tabular nonmagnetic powder has a major axis length ranging from 0.04 to 0.2 μm, a minor axis length equal to or less than 0.04 μm, and an acicular ratio equal to or higher than 2. When the major axis length is less than 0.04 μm, the effect achieved by the shape of the powder as mentioned above decreases and the surface becomes rough; when greater than 0.2 μm, the surface becomes rough due to increased effective displacement as a result of overlapping of nonmagnetic particles in the direction of thickness of the nonmagnetic layer. For the same reasons, the surface becomes rough when the minor axis length exceeds 0.04 μm. The minor axis length is desirably 0.005 to 0.03 μm. The ratio (1x/K) (acicular ratio) of the major axis length 1x to the minor axis length K is equal to or higher than 2, preferably equal to or higher than 5, and still more preferably, equal to or higher than 10. When the acicular ratio is less than 2, the effect achieved by the shape of the powder as mentioned above decreases and the surface becomes rough. The number of acicular particles m linked in the minor axis direction is desirably 2 to 5, preferably 3 to 5. For achieving the minor axis length of the clustered tabular nonmagnetic powder equal to or less than 0.04 μm, the value K/m obtained by dividing the minor axis length by the number of particles m is desirably equal to or less than 0.02 μm, preferably equal to or less than 0.01 μm.

During coating of the nonmagnetic layer, the clustered tabular nonmagnetic powder tend to orientate such that the major axis of the particles lie parallel to the base (support) surface. Further, the clustered tabular nonmagnetic powder has a lesser tendency to interlock and form aggregates in the nonmagnetic layer than those of acicular nonmagnetic powders and oblate acicular powders. Clustered tabular nonmagnetic powders are advantageous relative to flake-shaped nonmagnetic powder in that orientation irregularity of the nonmagnetic powder in the direction of thickness (direction perpendicular to the tape web) can be improved. Thus, the incorporation of clustered tabular nonmagnetic powder into the nonmagnetic layer reduces surface roughening during film formation, improves the shaping properties of the nonmagnetic layer during calendering, and permits a magnetic layer with a smooth surface.

The clustered tabular nonmagnetic powder employed in the present invention may be, for example, α-iron oxide. Clustered tabular nonmagnetic powder consisting of α-iron oxide may be obtained, for example, by altering the conditions under which iron hydroxide is sintered to obtain α-iron oxide, that is, using a more gradual process than the usual sintering method.

The major axis length and minor axis length of clustered tabular nonmagnetic powder are controlled by the size of the iron hydroxide starting material. The sintering temperature and duration may be adjusted to manufacture α-iron oxide in which plural acicular particles are linked into a clustered tabular shape in the minor axis direction.

Clustered tabular nonmagnetic powder comprised of α-iron oxide is characterized by a larger specific surface area due to sintering conditions and shape than acicular α-iron oxide prepared from the same iron hydroxide. Clustered tabular nonmagnetic powder can be verified by high-magnification TEM observation, as stated above.

The admixture of granular nonmagnetic powders such as carbon black to the nonmagnetic layer of the magnetic recording medium of the present invention is a countermeasure to electrostatic charging and permits the preparation of a magnetic recording medium with little surface roughness during coating by controlling the fluidity of the coating liquid. In this case, the ratio (1x/1y) of the major axis length 1x of the clustered tabular nonmagnetic powder to the mean particle diameter 1y of the granular nonmagnetic powder mentioned above is desirably equal to or higher than 3, preferably equal to or higher than 5, and still more preferably, equal to or higher than 10 from the perspective of controlling orientation irregularity due to overlapping of particles during admixture. Further, the ratio (K/1y) of the minor axis length K of the clustered tabular nonmagnetic powder to the mean particle diameter 1y of the granular nonmagnetic powder desirably ranges from 0.3 to 2, preferably from 0.5 to 1.5, and still more preferably, from 0.8 to 1.2 from the perspective of controlling overlapping of clustered tabular nonmagnetic powder and granular particles.

The ratio (d/1x) of the nonmagnetic layer thickness d and the major axis length 1x of the clustered tabular nonmagnetic powder in the magnetic recording medium of the present invention desirably ranges from 0.05 to 25, preferably from 0.1 to 10, and still more preferably, from 0.1 to 4 from the perspective of further improving orientation in the direction of thickness and achieving a smooth surface. When d/1x is equal to or less than 4, it becomes difficult that granular particles enter between the clustered tabular nonmagnetic powder particles, and clustered tabular particles and granular particles such as carbon black are both present on the same flat surface. That is, the clustered tabular nonmagnetic powder particles are randomly oriented within the surface with granular particles such as carbon black present in the gaps therebetween. Thus, not only a smooth surface is obtained, but also the strength of the nonmagnetic layer in the width direction is increased and it is possible to more effectively squash the upper magnetic layer during calendering. Running durability, such as edge damage during repeated running of tapes, is also improved.

From the same perspective, the granular nonmagnetic particles may be something other than carbon black, such as a ceramic, e.g. titanium oxide or an organic filler. However, the particle size of the granular nonmagnetic particles is desirably equal to or less than 0.04 μm, preferably equal to or less than 0.02 μm.

The content of clustered tabular nonmagnetic powder preferably ranges from 10 to 100 weight parts, more preferably from 60 to 95 weight parts, per 100 weight parts of the total nonmagnetic powder contained in the nonmagnetic layer. The average thickness of the magnetic layer ranges from 0.01 to 0.2 μm, preferably from 0.02 to 0.12 μm, and still more preferably, from 0.04 to 0.1 μm. The ratio of the magnetic layer thickness to the nonmagnetic layer thickness ranges from 0.02 to 0.5, preferably from 0.03 to 0.2, and still more preferably, from 0.03 to 0.1.

Prescribing the upper magnetic layer thickness and the ratio of the thickness of the magnetic layer to that of the nonmagnetic layer in this manner permits the reflection on the outer surface of the magnetic layer of a (smooth) nonmagnetic layer surface that has been rendered smooth through the use of clustered tabular nonmagnetic powder. That is, as the magnetic layer becomes thinner, it becomes easier that the effect of smoothing the nonmagnetic layer surface is reflected on the outer surface of the magnetic layer.

Since orientation during film formation decreases when the lower nonmagnetic layer is made excessively thick, the shape effect that the lower nonmagnetic powder has in smoothing the lower layer surface decreases. Generally, when the lower nonmagnetic layer thickness is made thick of equal to or higher than 4 μm, problems such as film separation and side surface fraying tend to occur. Thus, the lower nonmagnetic layer thickness suitably ranges from 0.2 to 3 μm, preferably from 0.4 to 1.8 μm, and still more preferably, from 0.8 to 1.8 μm. When the nonmagnetic layer is made thin, orientation during film formation improves, but calender shaping properties deteriorate, so the above-stated ranges are desirable.

The use of a smooth flexible nonmagnetic support (base) makes it possible to avoid the problem of output reduction due to spacing in lower limit samples of the above-described nonmagnetic layer thickness. Thus, the use of a base in which rough protrusions (protrusions of 50 nm or more) have been reduced is desirable. When the nonmagnetic layer thickness is equal to or higher than 0.8 μm, the effect by base surface properties is weak, but the combined use of a base in which the 2 to 10 μm wavelength roughness component has been reduced is particularly effective at reducing modulation noise.

The quantity of binder resin in the lower nonmagnetic layer suitably ranges from 5 to 30 weight parts per 100 weight parts of the total quantity of nonmagnetic powder. This is desirable both from the perspective of ensuring good calender shaping properties and ensuring dispersibility in the liquid. When the quantity of binder resin is excessive, calender shaping properties tend to deteriorate, and when the quantity of binder resin is inadequate, dispersibility tends to decrease.

When applying a thin nonmagnetic layer by coating, thinning the lower nonmagnetic liquid facilitates coating. However, when the concentration of the lower nonmagnetic liquid is lowered, aggregation of nonmagnetic particles in the liquid becomes problematic. Thus, the binder employed in the nonmagnetic layer is desirably a polyurethane resin comprising a polar group. The polyurethane resin is further desirably a polyurethane resin having a ring structure and an ether group, a branching aliphatic polyester polyurethane, polyurethane having a dimer diol structure, or the like. Since these binders adsorb onto the outer surface of the particles and form long molecular chains of suitable hardness, it is possible to increase the spacing between particles in the liquid and inhibit particle aggregation. Further, since aggregation of particles can also be inhibited during drying of the coating, it is possible to form a film with little irregularity due to particle aggregation. The urethane resins may be employed singly or in combination. The proportion of urethane resin present in the binder in the nonmagnetic layer is desirably equal to or higher than 10 weight percent, preferably equal to or higher than 20 weight percent.

Smoothing the magnetic layer surface with a smooth means once the coating film has dried to some degree tends to improve particle orientation in the upper and lower layers. Further, it is preferable to break up particle aggregates by applying a shearing force to a coating liquid by increasing a coating rate or, when employing extrusion coating method, by devising the shape of gither slit. Slowing initial drying of the coating to inhibit eddy current movement in the coating liquid can further improve particle orientation.

Calendering is desirably conducted under the following conditions. The initial roll nip is configured of all metal rolls with a nip linear pressure equal to or higher than 300 kg/cm, preferably equal to or higher than 400 kg/cm; the processing rate is equal to or less than 150 m/min, preferably equal to or less than 100 m/min, and still more preferably, equal to or less than 30 m/min; and the temperature falls within the range of 70 to 100 ° C. The nip linear pressure, processing rate, and temperature are set in each case to facilitate shaping of the upper and lower layers, which is affected by the Tg, type, and quantity of binder employed in the upper magnetic layer and lower nonmagnetic layer.

When the medium is to be used with MR heads, the use of a magnetic powder in the form of a ferromagnetic metal powder having a major axis length of 0.04 to 0.1 μm and an acicular ratio equal to or higher than 4, or a hexagonal ferrite powder with a plate ratio of 2 to 5, in combination with the effect achieved by employing a microgranular magnetic material in the upper layer, further enhances the effect of the present invention. Further, the above-mentioned microgranular magnetic material is desirable in media for use with MR heads from the perspective of reducing AC demagnetization noise. That is, when combined with the above-described microgranular magnetic powder, the configuration of the present invention permits the manufacturing of a particulate medium with low AC demagnetization noise and low modulation noise (DC magnetization noise).

The magnetic layer of the magnetic recording medium of the present invention is described in greater detail below.

The magnetic recording medium of the present invention may be in the form of a single magnetic layer or multiple (multilayered) magnetic layers. In the case of multiple (multilayered) magnetic layers, the technique described in Japanese Unexamined Patent Publication (KOKAI) Heisei No. 6-139555 may be applied, for example.

In the magnetic recording medium of the present invention, since a saturated recording state occurs due to the comparative thinness of the magnetic layer, there would ideally be no variation in the thickness of the magnetic layer. However, a relation between the thickness d of the magnetic layer and the standard deviation a of the thickness of σ/d≦0.5 is permissible in practical terms, with σ/d≦0.3 being preferred. As described in Japanese Patent No. 2,566,096, specific methods of reducing σ are to render the lower layer nonmagnetic coating liquid thixotropic, employ acicular nonmagnetic powder in the lower layer, and employ a wet on dry method of coating the magnetic upper layer after coating and drying the nonmagnetic lower layer, and the like. The residual magnetization of the magnetic layer ranges from 6.28×10⁻⁴ to 6.28×10⁻³ mT. The residual magnetization is optimized based on the recording and reproduction methods. There are various methods of setting the above-stated residual magnetization. For example, when the medium is being reproduced with an inductive head, the residual magnetization is set somewhat high within the above-mentioned range. When setting the magnetic layer somewhat thin (equal to or less than 0.1 μm, for example) due to O/W requirements, it is desirable to employ an alloy powder with a large (for example, 140 to 160 A·m²/kg) σs as the magnetic powder.

Further, when reproducing with an MR head, the number of particles is preferably increased and the residual magnetization is preferably set somewhat low within the above-stated range. In that case, it is appropriate that a magnetic powder with an σs of 50 to 130 A·m²/kg is employed and the quantity of binder in the upper and lower layers is reduced, and the like to improve the fill density to the extent possible.

An alloy powder with an σs of 100 to 130 A·m²/kg or hexagonal ferrite, magnetite, or Co-ferrite with an σs of 50 to 80 A·m²/kg can be employed as the magnetic powder used in the present invention.

In addition to prescribed atoms, the following atoms can be contained in the magnetic powder: Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, and the like. For improving thermal stability, Al, Si, Ta, Y, or the like may be adhered to the surface or dissolved therein as a solid. The addition of Co, Sm, Nd, or the like in a proportion of 5 to 40 weight percent relative to Fe is well known especially to increase the Hc.

The magnetic powder may be pretreated prior to dispersion with dispersing agents, lubricants, surfactants, antistatic agents, and the like.

The size of the magnetic particles is, as a matter of course, as small as possible within the range not appearing the effect of thermal fluctuation, and does not depend on the reproduction head. Practically speaking, for acicular particles, a mean major axis length of 0.05 to 0.2 μm and a minor axis length of 0.01 to 0.025 μm are currently employed. In hexagonal ferrite, a plate diameter of 0.01 to 0.2 μm and a thickness of 0.001 to 0.1 μm are currently employed. The preferred range is not limited thereto; when advances in technology yield smaller particle sizes, those particles may be employed.

The coercive force Hc of the magnetic layer ranges from 119 to 318 kA/m, preferably from 143 to 279 kA/m, and more preferably from 159 to 239 kA/m. Thus, the above-described magnetic powder preferably has the same Hc.

The ferromagnetic metal powder employed in the present invention is not specifically limited. However, an alloy with Fe as its chief component is preferred. In addition to prescribed atoms, the following atoms can be contained in the ferromagnetic metal powder: Al, Mg, Si, S, Sc, Ca, Ti, V, Cr, Cu, Y, Mo, Rh, Pd, Ag, Sn, Sb, Te, Ba Ta, W, Re, Au, Hg, Pb, Bi, La, Ce, Pr, Nd, P, Co, Mn, Zn, Ni, Sr, B, and the like. The incorporation of at least one of the following in addition to Fe is particularly desirable: Al, Mg, Si, Ca, Y, Ba, La, Nd, Co, Ni, and B.

The ferromagnetic metal powder may be pretreated prior to dispersion with dispersing agents, lubricants, surfactants, antistatic agents, and the like, described further below. Specific examples are described in Japanese Examined Patent Publication (KOKOKU) Showa Nos. 44-14090, 45-18372, 47-22062, 47-22513, 46-28466, 46-38755, 47-4286, 47-12422, 47-17284, 47-18509, 47-18573, 39-10307 and 48-39639; and U.S. Pat. Nos. 3,026,215, 3,031,341, 3,100,194, 3,242,005, and 3,389,014.

The ferromagnetic metal powder may contain a small quantity of hydroxide or oxide. Ferromagnetic metal powders obtained by known manufacturing methods may be employed. The following are examples: methods of reduction with compound organic acid salts (chiefly oxalates) and reducing gases such as hydrogen; methods of reducing iron oxide with a reducing gas such as hydrogen to obtain Fe or Fe—Co particles or the like; methods of thermal decomposition of metal carbonyl compounds; methods of reduction by addition of a reducing agent such as sodium boron hydride, hypophosphite, or hydrazine to an aqueous solution of ferromagnetic metal; and methods of obtaining micropowder by vaporizing a metal in a low-pressure non-reactive gas. The ferromagnetic metal powders obtained in this manner may be subjected to any of the known slow oxidation treatments, such as immersion in an organic solvent followed by drying; the method of immersion in an organic solvent followed by formation of an oxide film on the surface by feeding in an oxygen-containing gas, then drying; and the method of forming an oxide film on the surface by adjusting the partial pressure of oxygen gas and a inert gas without using an organic solvent.

The specific surface area as measured by BET method of the ferromagnetic metal powder employed in the magnetic layer of the present invention is preferably selected from within the range of 30 to 50 m²/g. This permits both good surface properties and low noise.

The shape of the ferromagnetic metal powder is preferably acicular, with an flat acicular shape being particularly preferred. However, granular, rice-particle, and plate-shaped shapes are also permissible.

The mean major axis length of the ferromagnetic metal powder preferably ranges from 0.04 to 0.15 μm, with 0.07 to 0.12 μm being preferred in media for the use of an inductive head, and with 0.04 to 0.08 μm being preferred in media for the use of an MR head.

The major axis length may be obtained by the method of taking transmission electron microscope photographs and directly reading the minor axis length and major axis length of the ferromagnetic powder from the photographs, and suitably combining the method of tracing transmission electron microscope photographs with an IBASSI image analyzer from Carl Zeiss Co. and reading them.

The acicular ratio of the ferromagnetic metal powder is preferably equal to or higher than 4 and equal to or less than 18, more preferably equal to or higher than 5 and equal to or less than 12. The moisture content of the ferromagnetic metal powder preferably ranges from 0.01 to 2 percent. The moisture content of the ferromagnetic metal powder is preferably optimized based on the type of binders.

The pH of the ferromagnetic metal powder is preferably optimized based on the combination of binders employed. The range is from 4 to 12, preferably from 7 to 10. As needed, Al, Si, P, or oxides thereof, and the like may be imparted to the surface of the ferromagnetic metal powder. The quantity thereof ranges from 0.1 to 10 weight percent with respect to the ferromagnetic metal powder. It is preferable that a surface treatment is applied, because the adsorption of lubricants such as fatty acids becomes equal to or less than 100 mg/m². Inorganic ions of soluble Na, Ca, Fe, Ni, Sr, and the like are sometimes incorporated into the ferromagnetic metal powder; characteristics are not particularly affected when the quantity thereof is equal to or less than 200 ppm.

Further, there are desirably few pores in the ferromagnetic metal powder employed in the present invention; the level thereof is equal to or less than 20 volume percent, preferably equal to or less than 5 volume percent.

Known binders may be employed in the magnetic layer. Examples are the binders described in Japanese Patent Publication Nos. 2566096 and 2571351. Functional groups (SO₃M, PO₃M, and the like) promoting adsorption with magnetic powder are desirably incorporated in the binder, with the incorporation of epoxy groups being further desirable. The molecular weight ranges from 10,000 to 100,000, preferably from 20,000 to 60,000. The quantity employed ranges from 5 to 25 parts, preferably from 5 to 20 parts, and still more preferably, from 5 to 15 parts per 100 parts by weight of magnetic powder.

Thermoplastic resins with a glass transition temperature ranging from −100 to 150° C., a number average molecular weight of 1,000 to 200,000, preferably from 10,000 to 100,000, and a degree of polymerization of about 50 to 1,000 may be employed as the binder in the magnetic layer. Examples of such resins are polymers and copolymers comprising structural units in the form of vinyl chloride, vinyl acetate, vinyl alcohol, maleic acid, acrylic acid, acrylic acid esters, vinylidene chloride, acrylonitrile, methacrylic acid, methacrylic acid esters, styrene, butadiene, ethylene, vinyl butyral, vinyl acetal, vinyl ether, and the like; polyurethane resin, and various gum-based resins.

Examples of thermosetting resins or reactive resins suitable for use as binders in the magnetic layer are phenol resins, epoxy resins, polyurethane hardening-type resins, urea resin, melamine resins, alkyd resins, acrylic reactive resins, formaldehyde resins, silicone resins, epoxy-polyamide resins, mixtures of polyester resins and isocyanate prepolymers, mixtures of polyester polyols and polyisocyanate, mixtures of polyurethane and polyisocyanate, and the like. These resins are described in detail in the Handbook of Plastics published by Asakura Shoten. It is also possible to employ known electron beam-cured resins in magnetic layers.

Examples thereof and methods of manufacturing the same are described in Japanese Unexamined Patent Publication (KOKAI) Showa No. 62-256219. The above-listed resins may be used singly or in combination. Preferred resins are combinations of polyurethane resin and at least one member selected from the group consisting of vinyl chloride resin; vinyl chloride-vinyl acetate copolymers; resins comprising individual repeating units derived from among the individual units of vinyl chloride, vinyl acetate, and vinyl alcohol; and vinyl chloride-vinyl acetate-maleic anhydride copolymers; or combinations of the same with polyisocyanate. Known structures of polyurethane resin can be employed, such as polyester polyurethane, polyether polyurethane, polyether polyester polyurethane, polycarbonate polyurethane, polyester polycarbonate polyurethane, polycaprolactone polyurethane, and polyolefin polyurethane. Polyurethanes comprised of short-chain diols having the above-described cyclic structure and long-chain diols comprising ester groups are particularly preferred. To obtain as needed better dispersibility and durability in all of the binders set forth above, it is desirable to use those introduced by copolymerization or addition reaction one or more polar groups selected from among —COOM, —SO₃M, —OSO₃M, —P═O(OM)₂, —O—P═O(OM)₂, (where M denotes a hydrogen atom or an alkali metal base), —OH, —NR₂, —N⁺R₃, (where R denotes a hydrocarbon group), epoxy groups, —SH, —CN, sulfobetaine, phosphobetaine, and carboxybetaine. The quantity of the polar group is from 10⁻¹ to 10⁻⁸ mol/g, preferably from 10⁻² to 10⁻⁶ mol/g.

Specific examples of the binders employed in the present invention are VAGH, VYHH, VMCH, VAGF, VAGD, VROH, VYES, VYNC, VMCC, XYHL, XYSG, PKHH, PKHJ, PKHC, and PKFE from Union Carbide Corporation.; MPR-TA, MPR-TA5, MPR-TAL, MPR-TSN, MPR-TMF, MPR-TS, MPR-TM, and MPR-TAO from Nisshin Kagaku Kogyo K. K.; 1000W, DX80, DX81, DX82, DX83, and 100FD from Denki Kagaku Kogyo K. K.; MR-104, MR-105, MR110, MR100, and 400X-110A from Nippon Zeon Co., Ltd.; Nippollan N2301, N2302, and N2304 from Nippon Polyurethane Industry Co., Ltd.; Pandex T-5105, T-R3080, T-5201, Burnock D-400, D-210-80, Crisvon 6109, and 7209 from Dainippon Ink And Chemicals, Incorporated.; Vylon UR8200, UR8300, RV530, and RV280 from Toyobo Co., Ltd.; Dipheramin 4020, 5020, 5100, 5300, 9020, 9022, and 7020 from DainichiSeika Colar & Chemicals Mfg. Co., Ltd.; MX5004 from Mitsubishi Chemical Corp.; Sunprene SP-150 and TIM-3003 from Sanyo Chemical Industries, Ltd.; and Salan F310 and F210 from Asahi Chemical Industry Co., Ltd. Of these, MR-104, MR110, UR-8200, UR8300, UR-8700, and polyurethanes that are reaction products, the principal starting materials of which are diols and organic diisocyanates and have cyclic structures and ether groups are preferred.

When polyurethane resins are employed in the present invention, the elongation at break preferably ranges from 100 to 2,000 percent, the stress at break preferably ranges from 0.05 to 10 kg/cm², and the yield point preferably ranges from 0.05 to 10 kg/cm².

Examples of polyisocyanates preferably employed in the present invention are tolylene diisocyanate, 4,4′-diphenylmethane diisocyanate, hexamethylene diisocyanate, xylylene diisocyanate, naphthylene-1,5-diisocyanate, o-toluidine diisocyanate, isophorone diisocyanate, triphenylmethane triisocyanate, and other isocyanates; products of these isocyanates and polyalcohols; polyisocyanates produced by condensation of isocyanates; and the like. These isocyanates are commercially available under the following trade names, for example: Coronate L, Coronate HL, Coronate 2030, Coronate 2031, Millionate MR and Millionate MTL manufactured by Nippon Polyurethane Industry Co. Ltd.; Takenate D-102, Takenate D-110N, Takenate D-200 and Takenate D-202 manufactured by Takeda Chemical Industries Co. Ltd.; and Desmodule L, Desmodule IL, Desmodule N and Desmodule HL manufactured by Sumitomo Bayer Co. Ltd. They can be used singly or in combinations of two or more in both the nonmagnetic layer and the magnetic layer by exploiting differences in curing reactivity. The polyisocyanates are normally employed in a quantity of 0 to 50 weight percent, preferably from 0 to 30 weight percent, per the total quantity of binder resin in the magnetic layer, and in a quantity of 0 to 40 weight percent, preferably from 0 to 25 weight percent, per the total quantity of binder in the nonmagnetic layer.

When the magnetic recording medium of the present invention comprises two or more layers, it is of course possible to change the quantity of binder resin, the proportion of vinyl chloride resin, polyurethane resin, polyisocyanate, or some other resin in the binder, the molecular weight of each of the resins forming the magnetic layer, the quantity of polar groups, and the physical characteristics of the above-described resins and the like as needed. Known techniques about multilayered magnetic layers may be applied.

When carbon black is employed in the magnetic upper layer of the present invention, examples of types of carbon black that are suitable for use are: furnace black for rubber, thermal for rubber, black for coloring, and acetylene black. A specific surface area of 5 to 500 m²/g, a DBP oil absorption capacity of 10 to 400 mL/100 g, a particle diameter of 5 nm to 300 nm, a pH of 2 to 10, a moisture content of 0.1 to 10 weight percent, and a tap density of 0.1 to 1 g/mL are desirable. Specific examples of types of carbon black employed in the present invention are: BLACK PEARLS 2000, 1300, 1000, 900, 800, 700 and VULCAN XC-72 manufactured by Cabot Corporation; #80, #60, #55, #50 and #35 manufactured by Asahi Carbon Co. Ltd.; #2400B, #2300, #900, #1000, #30, #40 and #10B manufactured by Mitsubishi Kasei Kogyo Corp.; and CONDUCTEX SC, RAVEN 150, 50, 40 and 15 manufactured by Columbia Carbon Co. Ltd. The carbon black employed may be surface-treated with a dispersant or the like, or grafted with resin, or have a partially graphite-treated surface. The carbon black may be dispersed in advance into the binder prior to addition to the magnetic coating material. These carbon blacks may be used singly or in combination.

When employing carbon black, the quantity preferably ranges from 0.1 to 30 weight percent of the ferromagnetic powder.

In the magnetic layer, carbon black works to prevent static buildup, reduce the coefficient of friction, impart light-blocking properties, enhance film strength, and the like; the properties vary with the type of carbon black. Accordingly, it is, as a matter of course, possible for carbon black used in the present invention to properly use varying the kinds, quantity and combination between the upper magnetic layer and lower layer according to the purpose on the basis of the above-mentioned characteristics, such as particle size, oil absorption capacity, electrical conductivity, and pH. For example, the Carbon Black Handbook compiled by the Carbon Black Association may be consulted for types of carbon black suitable for use in the magnetic layer of the present invention.

Known abrasives such as α-alumina and Cr₂O₃ may be incorporated into the magnetic layer. For wet-on-wet coating, the mean particle diameter is desirably equal to or higher than ⅓ and equal to or less than 5 times the thickness of the magnetic layer, and for wet-on-dry coating, the mean particle diameter is desirably equal to or higher than ⅓ and equal to or less than twice the thickness of the magnetic layer. An excessively large mean particle diameter causes thermal asperity. Since the abrasive tends particularly to protrude in wet-on-dry coatings, microparticles are preferred. Known techniques may be employed for pH and surface treatment.

In addition, solid lubricants (carbon with a particle diameter equal to or higher than 30 nm), fatty acids, fatty esters, and other liquid lubricants may be added to the magnetic layer.

The lower nonmagnetic layer will be described below.

The lower nonmagnetic layer of the magnetic recording medium of the present invention comprises a clustered tabular nonmagnetic powder. The clustered tabular nonmagnetic powder is as set forth above. In addition to clustered tabular nonmagnetic powder, the usual acicular and plate-like nonmagnetic powders may be employed in combination as nonmagnetic powder, but the quantity employed thereof is desirably kept low to achieve the effect of the present invention. Further, the granular nonmagnetic powder has a mean particle diameter equal to or less than 0.04 μm, preferably falling within the range of 0.005 to 0.03 μm, and still more preferably, within the range of 0.005 to 0.02 μm.

Specific examples of granular nonmagnetic powders that may be selected for use are carbon black, metal oxides, metal carbonates, metal sulfates, metal nitrides, metal carbides, metal sulfides, and other inorganic compounds. Particularly preferred inorganic compounds are those readily yielding microparticles, such as titanium dioxide, zinc oxide, zirconium oxide, tin oxide, ITO (Sn/In₂O₃) powder, silicon dioxide, boron nitride, and magnesium oxide.

The particle size of granular inorganic compound powders is measured in the same manner as that of ferromagnetic metal powders. The tap density ranges from 0.05 to 2 g/mL, preferably from 0.2 to 1.5 g/mL. The moisture content of granular inorganic compound powders ranges from 0.1 to 5 weight percent, preferably from 0.2 to 3 weight percent, and still more preferably from 0.3 to 1.5 weight percent. The pH of granular inorganic compound powders ranges from 2 to 11, with a pH of 7 to 10 being particularly desirable. The specific surface area of the granular inorganic compound powders ranges from 1 to 100 m²/g, preferably from 5 to 70 m²/g, and still more preferably from 10 to 65 m²/g. The crystalline size of the granular inorganic compound powders desirably ranges from 0.004 to 0.04 μm. The oil absorption capacity using dibutyl phthalate (DBP) ranges from 5 to 100 mL/100 g, preferably from 10 to 80 mL/100 g, and still more preferably from 20 to 60 mL/100 g. The specific gravity ranges from 1 to 12, preferably from 3 to 6. The shape may be spherical, polyhedral, or plate-shaped.

It is considered that the ignition loss is desirably equal to or less than 20 weight percent, with no loss at all being most preferred. The Mohs' hardness of the above-mentioned nonmagnetic inorganic compound powder employed in the present invention is preferably equal to or higher than 4 and equal to or less than 10. The roughness factor of the powder surface preferably ranges from 0.8 to 1.5, more preferably from 0.9 to 1.2. The stearic acid (SA) adsorption amount of the above-mentioned nonmagnetic inorganic compound powders ranges from 1 to 20 μmol/m², preferably from 2 to 15 μmol/m². The heat of wetting in 25° C. water of the above-mentioned nonmagnetic inorganic compound powder is preferably within the range of 20 to 60 μJ/cm. A solvent with a heat of wetting within this range may also be employed. The quantity of water molecules on the surface at 100 to 400° C. suitably ranges from 1 to 10 pieces per 100 Angstroms. The pH of the isoelectric point in water preferably ranges from 3 to 9.

The surfaces of these nonmagnetic inorganic compound powders are preferably treated so that Al₂O₃, SiO₂, TiO₂, ZrO₂, SnO₂, Sb₂O₃, and ZnO are present Al₂O₃, SiO₂, TiO₂, and ZrO₂ have particularly desirable dispersion properties. Al₂O₃, SiO₂, and ZrO₂ are even more preferred. These may be employed singly or in combination. Depending on the objective, a surface-treated coating layer with a coprecipitated material may also be employed, the coating structure which comprises a first alumina coating and a second silica coating thereover or the reverse structure thereof may also be adopted. Depending on the objective, the surface-treated coating layer may be a porous layer, but homogeneity and density are generally desirable.

Specific examples of granular nonmagnetic inorganic compound powders suitable for use in the nonmagnetic layer of the present invention are: titanium oxide TTO-51B, TTO-53B, TTO-55A, TTO-55B, TTO-55C, TTO-55S, TTO-55D, and SN-100 from Ishihara Sangyo Co., Ltd.; UBE-100A and UBN-100A from Ube Industries Co., Ltd.; HZN from Hokko Kagaku K. K.; RC and EP from Daiichi Kigenso Kogyo Co., Ltd.; TZ-0 and TZ-3Y from Toso Co., Ltd.; and sintered products thereof.

The carbon black that is added to the nonmagnetic layer as granular nonmagnetic particles has, for example, a specific surface area of 100 to 500 m²/g, preferably from 150 to 400 m²/g and a DBP oil absorption capacity of 20 to 400 mL/100 g, preferably from 30 to 200 mL/100 g. The particle diameter of the carbon black is equal to or less than 0.04 μm, preferably from 0.01 to 0.03 μm, and still more preferably from 0.01 to 0.02 μm. The oil absorption capacity of the carbon black is equal to or less than 200 mL/100 g, preferably equal to or less than 100 mL/100 g. It is preferred for carbon black that the pH ranges from 2 to 10, the moisture content ranges from 0.1 to 10 percent, and the tap density ranges from 0.1 to 1 g/mL.

Specific examples of types of carbon black employed as granular nonmagnetic particles in the present invention are: BLACK PEARLS 2000, 1300, 1000, 900, 800, 880, 700, and VULCAN XC-72 from Cabot Corporation.; #3050B, #3150B, #3250B, #3750B, #3950B, #950, #650B, #970B, #850B, and MA-600 from Mitsubishi Chemical Corporation; CONDUCTEX SC, RAVEN 8800, 8000, 7000, 5750, 5250, 3500, 2100, 2000, 1800, 1500, 1255, and 1250 from Columbia Carbon Co., Ltd.; and Ketjen Black EC from Lion Akzo Co., Ltd. The carbon black employed can be surface treated with a dispersing agent or the like, grafted with a resin, or a portion of the surface may be graphite-treated. Further, the carbon black may be dispersed with a binder prior to being added to the coating material. These carbon blacks are employed in a range of 5 to 50 parts by weight, preferably from 10 to 30 parts by weight, and more preferably from 15 to 25 parts by weight, per 100 parts by weight of the total nonmagnetic powder employed in the nonmagnetic layer. These carbon blacks may be employed singly or in combination.

The Carbon Black Handbook compiled by the Carbon Black Association may be consulted for types of carbon black suitable for use in the nonmagnetic layer.

When employed in combination with the above-described granular nonmagnetic inorganic compounds, it is appropriate that the total quantity of carbon black and the inorganic compounds ranges from 5 to 50 parts by weight per 100 parts by weight of the total quantity of nonmagnetic powder, and the quantity of carbon black ranges from 5 to 25 parts by weight, preferably from 5 to 20 parts by weight, and still more preferably from 5 to 15 parts by weight.

The same binder as employed in the magnetic upper layer may be employed in the nonmagnetic layer, but the incorporation of functional groups (listed above) enhancing dispersibility is further preferred. The molecular weight ranges from 20,000 to 50,000, preferably from 30,000 to 50,000. The calendering molding effect deteriorates when the molecular weight is excessively high. Surface treatment with aromatic phosphorus compounds promoting dispersion in the nonmagnetic powder is further effective. This is described in detail in Japanese Patent Nos. 2,566,088 and 2,634,792.

The binder weight B (L) in the lower nonmagnetic layer ranges from 12 to 30 parts, preferably from 15 to 25 parts, per 100 parts by weight of the total of the principal components in the form of flat acicular α-iron oxide powder and granular nonmagnetic particles such as carbon black. A greater weight than that of the binder in the upper layer is desirably employed.

In the magnetic layer, carbon black works to prevent static, reduce the friction coefficient, impart light-blocking properties, enhance film strength, and the like; the properties vary with the type of carbon black. Accordingly, it is, as a matter of course, possible for carbon black used in the present invention to properly use varying the kinds, quantity and combination between the upper magnetic layer and lower layer according to the purpose on the basis of the above-mentioned characteristics, such as particle size, oil absorption capacity, electrical conductivity, and pH. For example, the Carbon Black Handbook compiled by the Carbon Black Association may be consulted for the type of carbon black to employ in the magnetic layer of the present invention.

It is, as a matter of course, possible for the abrasive used in the present invention to properly use varying the kinds, quantity and combination between the magnetic layers (upper and lower layers) and nonmagnetic layer, according to the purpose. The abrasive employed in the magnetic layer suitably has a mean particle diameter of 0.01 to 0.3 μm, preferably from 0.01 to 0.2 μm, and still more preferably from 0.01 to 0.1 μm. The quantity of abrasive that is added appropriately ranges from 0.1 to 10 parts by weight, preferably from 0.5 to 5 parts by weight, per 100 parts by weight of magnetic material. The abrasive is desirably first dispersed in binder to form a dispersion and the added to the magnetic coating material.

Substances having lubricating effects, antistatic effects, dispersion effects, plasticizing effects, or the like may be employed as additives in the present invention. Examples are: molybdenum disulfide; tungsten graphite disulfide; boron nitride; graphite fluoride; silicone oils; silicones having a polar group; fatty acid-modified silicones; fluorine-containing silicones; fluorine-containing alcohols; fluorine-containing esters; polyolefins; polyglycols; alkylphosphoric esters and their alkali metal salts; alkylsulfuric esters and their alkali metal salts; polyphenyl ethers; fluorine-containing alkylsulfuric esters and their alkalilmetal salts; monobasic fatty acids having 10 to 24 carbon atoms (which may contain an unsaturated bond or may be branched) and metal (e.g., Li, Na, K, Cu) salts thereof; monohydric, dihydric, trihydric, tetrahydric, pentahydric and hexahydric alcohols having 12 to 22 carbon atoms (which may contain an unsaturated bond or be branched); alkoxy alcohols having 12 to 22 carbon atoms; monofatty esters, difatty esters, or trifatty esters comprising a monobasic fatty acid having 10 to 24 carbon atoms (which may contain an unsaturated bond or be branched) and any one from among a monohydric, dihydric, trihydric, tetrahydric, pentahydric or hexahydric alcohol having 2 to 12 carbon atoms (which may contain an unsaturated bond or be branched); fatty esters of monoalkyl ethers of alkylene oxide polymers; fatty acid amides having 8 to 22 carbon atoms; and aliphatic amines having 8 to 22 carbon atoms.

Specific examples of compounds suitable for use are: lauric acid, myristic acid, palmitic acid, stearic acid, behenic acid, butyl stearate, oleic acid, linolic acid, linolenic acid, elaidic acid, octyl stearate, amyl stearate, isooctyl stearate, octyl myristate, butoxyethyl stearate, anhydrosorbitan monostearate, anhydrosorbitan distearate, anhydrosorbitan tristearate, oleyl alcohol and lauryl alcohol. It is also possible to employ nonionic surfactants such as alkylene oxide-based surfactants, glycerin-based surfactants, glycidol-based surfactants and alkylphenolethylene oxide adducts; cationic surfactants such as cyclic amines, ester amides, quaternary ammonium salts, hydantoin derivatives, heterocycles, phosphoniums, or sulfoniums; anionic surfactants comprising acid groups such as carboxylic acid, sulfonic acid, phosphoric acid, sulfuric ester groups, and phosphoric ester groups; and ampholytic surfactants such as amino acids, amino sulfonic acids, sulfuric or phosphoric esters of amino alcohols, and alkyl betaines.

Details of these surfactants are described in “Surfactants Handbook” (published by Sangyo Tosho Co., Ltd.). These lubricants, antistatic agents and the like need not be V 100 percent pure and may contain impurities, such as isomers, unreacted materials, by-products, decomposition products and oxides in addition to the main components. These impurities are preferably comprised equal to or less than 30 percent, and more preferably equal to or less than 10 percent.

The lubricants and surfactants that are employed in the present invention may be employed differently in the lower layer and magnetic upper layer as needed based on type and quantity. For example, it is conceivable to control bleeding onto the surface through the use in the lower layer and the magnetic upper layer of fatty acids having different melting points, to control bleeding onto the surface through the use of esters having different boiling points and polarities, to improve coating stability by adjusting the amount of surfactant, and to enhance the lubricating effect by increasing the amount of the lubricant added to the nonmagnetic layer; this is not limited to the examples given here. All or some of the additives used in the present invention may be added at any stage of the process of manufacturing process the magnetic liquid. For example, they may be mixed with the ferromagnetic powder before a kneading step; added during a step of kneading the ferromagnetic powder, the binder, and the solvent; added during a dispersing step; added after dispersing; or added immediately before coating. Part or all of the additives may be applied by simultaneous or sequential coating after the magnetic layer has been applied to achieve a specific purpose. Depending on the objective, the lubricant may be coated on the surface of the magnetic layer after calendering or making slits.

Examples of the trade names of lubricants suitable for use in the present invention are: NAA-102, NAA-415, NAA-312, NAA-160, NAA-180, NAA-174, NAA-175, NAA-222, NAA-34, NAA-35, NAA-171, NAA-122, NAA-142, NAA-160, NAA-173K, hydrogenated castor oil fatty acid, NAA-42, NAA-44, Cation SA, Cation MA, Cation AB, Cation BB, Nymeen L-201, Nymeen L-202, Nymeen S-202, Nonion E-208, Nonion P-208, Nonion S-207, Nonion K-204, Nonion NS-202, Nonion NS-210, Nonion HS-206, Nonion L-2, Nonion S-2, Nonion S-4, Nonion O-2, Nonion LP-20R, Nonion PP-40R, Nonion SP-60R, Nonion OP-80R, Nonion OP-85R, Nonion LT-221, Nonion ST-221, Nonion OT-221, Monogly MB, Nonion DS-60, Anon BF, Anon LG, butyl stearate, butyl laurate, and erucic acid manufactured by NOF Corporation.; oleic acid manufactured Kanto Chemical Co. Ltd; FAL-205 and FAL-123 manufactured by Takemoto Oil & Fat Co., Ltd.; NJLUB LO, NJLUB IPM, and Sansosyzer E4030 manufactured by New Japan Chemical Co. Ltd.; TA-3, KF-96, KF-96L, KF96H, KF410, KF420, KF965, KF54, KF50, KF56, KF907, KF851, X-22-819, X-22-822, KF905, KF700, KF393, KF-857, KF-860, KF-865, X-22-980, KF-101, KF-102, KF-103, X-22-3710, X-22-3715, KF-910 and KF-3935 manufactured by Shin-Etsu Chemical Co.Ltd.; Armide P, Armide C and Armoslip CP manufactured by Lion Armour Co., Ltd.; Duomine TDO manufactured by Lion Corporation; BA-41G manufactured by Nisshin Oil Mills, Ltd.; Profan 2012E, Newpole PE61, Ionet MS-400, Ionet MO-200, Ionet DL-200, Ionet DS-300, Ionet DS-1000 and Ionet DO-200 manufactured by Sanyo Chemical Industries, Ltd.

The organic solvent employed in the present invention may be used in any ratio. Examples are ketones such as acetone, methyl ethyl ketone, methyl isobutyl ketone, diisobutyl ketone, cyclohexanone, isophorone, and tetrahydrofuran; alcohols such as methanol, ethanol, propanol, butanol, isobutyl alcohol, isopropyl alcohol, and methylcyclohexanol; esters such as methyl acetate, butyl acetate, isobutyl acetate, isopropyl acetate, ethyl lactate, and glycol acetate; glycol ethers such as glycol dimethyl ether, glycol monoethyl ether, and dioxane; aromatic hydrocarbons, such as benzene, toluene, xylene, cresol, and chlorobenzene; chlorinated hydrocarbons such as methylene chloride, ethylene chloride, carbon tetrachloride, chloroform, ethylene chlorohydrin, and dichlorobenzene; N,N-dimethylformamide; and hexane. These organic solvents need not be 100 percent pure and may contain impurities such as isomers, unreacted materials, by-products, decomposition products, oxides and moisture in addition to the main components. The content of these impurities is preferably equal to or less than 30 percent, more preferably equal to or less than 10 percent. Preferably the same type of organic solvent is employed in the present invention for the magnetic layer liquid and nonmagnetic layer liquid. However, the amount added may be varied. The stability of coating is increased by using a solvent with a high surface tension (such as cyclohexanone or dioxane) in the nonmagnetic layer. Specifically, it is important that the arithmetic mean value of the upper layer solvent composition not be less than the arithmetic mean value of the lower layer solvent composition. To improve dispersion properties, a solvent having a somewhat strong polarity is desirable. It is desirable that solvents having a dielectric constant equal to or higher than 15 is comprised equal to or higher than 50 percent of the solvent composition. Further, the dissolution parameter is desirably from 8 to 11.

The thickness of the flexible nonmagnetic support of the magnetic recording medium of the present invention is suitably from 1 to 100 μm, preferably from 4 to 80 μm. An undercoating layer can be provided between the flexible nonmagnetic support and the lower layer to improve adhesion.

The thickness of this undercoating layer is from 0.01 to 2 μm, preferably from 0.02 to 0.5 μm. In addition, a backcoat layer may be provided on the opposite side of the nonmagnetic support from the magnetic layer side. The thickness thereof is from 0.1 to 2 μm, preferably from 0.3 to 1.0 μm. Known undercoating layers and backcoat layers can be employed.

Known films can be employed as the flexible nonmagnetic support used in the present invention, including polyesters such as polyethylene terephthalate and polyethylene naphthalate, polyolefins, cellulose triacetate, polycarbonates, polyamides, polyimides, polyamidoimides, polysulfones, aramide, and aromatic polyamides. These supports may be subjected beforehand to corona discharge treatment, plasma treatment, adhesion enhancing treatment, heat treatment, dust removal, and the like.

A nonmagnetic flexible support is suitably employed that has a Power Spectrum Density of Roughness (abbreviated to “PSD”) equal to or less than 0.5 nm², preferably equal to or less than 0.4 nm², more preferably equal to or less than 0.3 nm² at a wavelength of 1 to 5 μm in the surface roughness spectrum measured by AFM, and a PSD ranging from 0.02 to 0.5 nm², preferably from 0.04 to 0.3 nm² at a wavelength of 0.5 to 1 μm. The shape of surface roughness can be freely controlled through the size and quantity of filler added to the support material, or by coating this filler dispersed in a binder. Examples of fillers are oxides and carbonates of Ca, Si, and Ti, as well as organic micropowders such as acrylic systems.

When the nonmagnetic support employed in the present invention is a tape, it is appropriate that the Young's modulus in the MD direction ranges from 3.92 to 14.7 GPa (400 to 1500 kg/mm²), preferably from 4.9 to 12.74 GPa, the Young's modulus in the TD direction ranges from 4.9 to 19.6 GPa, preferably from 6.86 to 17.64 GPa, and the ratio of TD/MD ranges from 1/1 to 1/5, preferably from 1/1 to 1/3.

The thermal shrinkage rate at 100° C. at 30 minutes in the tape running direction and the crosswise direction of the support is preferably equal to or less than 3 percent, more preferably equal to or less than 1.5 percent, and the thermal shrinkage rate at 80° C. at 30 minutes is preferably equal to or less than 1 percent, and more preferably equal to or less than 0.5 percent. The break strength in both directions preferably ranges from 0.049 to 0.98 GPa (5 to 100 kg/mm²).

The process for manufacturing the magnetic coating liquid for the magnetic recording medium of the present invention comprises at least a kneading step, a dispersing step, and a mixing step to be carried out, if necessary, before or after the kneading and dispersing steps. Each of the individual steps may be divided into two or more stages. All of the starting materials employed in the present invention, including the ferromagnetic powder, binders, carbon black, abrasives, antistatic agents, lubricants, solvents, and the like, may be added at the beginning or during any of the steps. Moreover, the individual materials may be divided and added during two or more steps; for example, polyurethane may be divided and added in the kneading step, the dispersing step, and the mixing step for viscosity adjustment after dispersion.

Conventionally known-manufacturing techniques may of course be utilized for some of the steps. In the kneading step, only by using a kneader having a strong kneading force, such as a continuous kneader or a pressure kneader, it is possible to obtain the magnetic recording medium having the high residual magnetic flux density (Br). When a continuous kneader or pressure kneader is employed, the ferromagnetic powder and all or part of the binder (preferably equal to or higher than 30 percent of the entire quantity of binder) are kneaded in the range of 15 to 500 parts by weight per 100 parts by weight of ferromagnetic powder. Details of the kneading treatment are described in Japanese Unexamined Patent Publication (KOKAI) Heisei No. 1-106338 and Japanese Unexamined Patent Publication (KOKAI) Showa No. 64-79274. When preparing the lower nonmagnetic layer liquid, a dispersing medium having a high specific gravity is desirably utilized, with zirconia beads being suitable.

The followings are examples of devices and methods for coating the magnetic recording medium having a multilayered structure of the present invention.

1. The lower layer is first applied with a coating device commonly employed to apply magnetic liquid such as a gravure coating, roll coating, blade coating, or extrusion coating device, and the upper layer is applied while the lower layer is still wet by means of a support pressure extrusion coating device such as is disclosed in Japanese Examined Patent Publication (KOKOKU) Heisei No. 1-46186 and Japanese Unexamined Patent Publication (KOKAI) Showa No. 60-238179 and Japanese Unexamined Patent Publication (KOKAI) Heisei No. 2-265672.

2. The upper and lower layers are applied nearly simultaneously by a single coating head having two built-in slits for passing coating liquid, such as is disclosed in Japanese Unexamined Patent Publication (KOKAI) Showa No. 63-88080, Japanese Unexamined Patent Publication (KOKAI) Heisei Nos. 2-17971, and 2-265672.

3. The upper and lower layers are applied nearly simultaneously using an extrusion coating apparatus with a backup roller as disclosed in Japanese Unexamined Patent Publication (KOKAI) Heisei No. 2-174965.

To prevent compromising the electromagnetic characteristics or the like of the magnetic recording medium by aggregation of magnetic powder, shear is desirably imparted to the coating liquid in the coating head by a method such as disclosed in Japanese Unexamined Patent Publication (KOKAI) Showa No. 62-95174 or Japanese Unexamined Patent Publication (KOKAI) Heisei No. 1-236968. In addition, the viscosity of the coating liquid must satisfy the numerical range specified in Japanese Unexamined Patent Publication (KOKAI) Heisei No. 3-8471. In some cases, to obtain the magnetic recording medium of the present invention, orientation must be strongly conducted. A solenoid equal to or higher than 100 mT (1,000 G) and a cobalt magnet equal to or higher than 200 mT (2,000 G) are desirably employed together in orientation with like poles opposed each other. It is also desirable to provide a suitable drying step prior to orientation so as to achieve the highest orientation property following drying. Further, when the present invention is being applied as a disk medium, an orientation method achieving random orientation is rather required. Further, to vary the orientation directions of an upper magnetic layer and a lower magnetic layer, the directions of orientation do not necessarily have to be the longitudinal direction and the in-plane direction; orientation in the vertical direction and widthwise direction is also possible.

Heat-resistant plastic rollers of epoxy, polyimide, polyamide, polyimidoamide or the like are employed as calender processing rollers. Processing may also be conducted with metal rollers. The processing temperature is preferably equal to or higher than 70° C., more preferably equal to or higher than 80° C. Linear pressure is desirably 200 kg/cm, more preferably equal to or higher than 300 kg/cm. The friction coefficient for SUS420J of the magnetic layer surface of the magnetic recording medium of the present invention and its opposite surface is preferably equal to or less than 0.5, more preferably equal to or less than 0.3. The specific surface resistivity preferably ranges from 10⁴ to 10¹² Ω/sq, the modulus of elasticity at 0.5 percent elongation of the magnetic layer in both the running direction and the width direction preferably ranges from 0.98 to 19.6 GPa and the break strength preferably ranges from 9.8×10⁻³ to 0.294 GPa. The modulus of elasticity of the magnetic recording medium in both the running direction and the longitudinal direction preferably ranges from 0.98 to 14.7 GPa and the residual elongation is preferably equal to or less than 0.5 percent. The thermal shrinkage rate at any temperature equal to or less than 100° C. is preferably equal to or less than 1 percent, more preferably equal to or less than 0.5 percent, and most preferably equal to or less than 0.1 percent. The glass transition temperature (i.e., the temperature at which the loss elastic modulus of dynamic viscoelasticity as measured at 110 Hz peaks) of the magnetic layer is preferably equal to or higher than 50° C. and equal to or less than 120° C., and that of the lower nonmagnetic layer preferably ranges from 0° C. to 100° C. The loss elastic modulus preferably falls within a range of 1×10³ to 8×10⁴ N/cm² and the loss tangent is preferably equal to or less than 0.2. Adhesion failure tends to occur when the loss tangent becomes excessively large.

The residual solvent in the magnetic layer is preferably equal to or less than 100 mg/m² and more preferably equal to or less than 10 mg/m², and the residual solvent contained in the second layer is preferably less than the residual solvent contained in the first layer. In both the nonmagnetic lower layer and the magnetic layer, the void ratio is preferably equal to or less than 30 volume percent, more preferably equal to or less than 20 volume percent. Although a low void ratio is preferable for attaining high output, there are some cases in which it is better to maintain a certain level. For example, in magnetic recording media for data recording where repeat applications are important, higher void ratios often result in better running durability. As regards the magnetic characteristics of the magnetic recording medium of the present invention, when measured under a magnetic field of 398 A/m, squareness in the tape running direction is equal to or higher than 0.70, preferably equal to or higher than 0.80, and more preferably equal to or higher than 0.90. Squareness in the two directions perpendicular to the tape running direction is preferably equal to or less than 80 percent of the squareness in the running direction. The switching field distribution (SFD) of the magnetic layer is preferably equal to or less than 0.6. On the magnetic layer surface, it is preferable that a PSD at a wavelength of 1 to 5 μm is equal to or less than 0.2 nm² and a PSD at a wavelength of 0.5 to 1.0 μm ranges from 0.02 to 0.1 nm² in a surface roughness spectrum measured by AFM. To achieve a good CNR, the lower PSD is better, but to improve running durability, it is necessary to keep the 0.5 to 1.0 μm wavelength PSD to 0.02 to 1.0 nm².

The magnetic recording medium of the present invention comprises a lower nonmagnetic layer and an upper magnetic layer. It will be readily understood that the physical characteristics of the nonmagnetic layer and the magnetic layer can be changed based on the objective. For example, the magnetic layer can be imparted with a high modulus of elasticity to improve running durability while at the same time imparting to the nonmagnetic layer a lower modulus of elasticity than that of the magnetic layer to improve head contact with the magnetic recording medium. What physical characteristics to be imparted to two or more magnetic layers can be determined by consulting techniques relating to known magnetic multilayers. For example, there are many inventions imparting a higher Hc to the upper magnetic layer than to the lower layer, such as disclosed in Japanese Examined Patent Publication (KOKOKU) Showa No. 37-2218 and Japanese Unexamined Patent Publication (KOKAI) Showa No. 58-56228. However, making the magnetic layer thin as in the present invention permits recording even on a magnetic layer of comparatively high Hc.

### EMBODIMENTS

The detailed contents of the present invention are described specifically below through embodiments. In the embodiments, “parts” denote “parts by weight”.

| (1) Nonmagnetic lower layer | | |
|---|---|---|
| Nonmagnetic powder α-Fe₂O₃ | 85 | parts |
| Carbon black (#950B) | 15 | parts |
| Mean primary particle diameter | 16 | mμ |
| DBP oil absorption capacity | 80 | ml/100 g |
| pH | 8.0 | |
| Specific surface area by BET method | 250 | m²/g |
| Volatile component | 1.5% | |
| Vinyl chloride copolymer | 7 | parts |
| MR-110 manufactured by Nippon Zeon Co., Ltd. | | |
| Polyester polyurethane resin | 5 | parts |
| Neopentylglycol/caprolactone polyol/MDI | | |
| (4, 4′-diphenylmethane diisocyanate) = 0.9/2.6/1 | | |
| 1 × 10⁻⁴ eq/g-SO₃Na group content | | |
| Butyl stearate | 1 | part |
| Stearic acid | 1 | part |
| Methyl ethyl ketone | 100 | parts |
| Cyclohexanone | 50 | parts |
| Toluene | 50 | parts |
| (2) Magnetic layer | | |
| Ferromagnetic metal powder | 100 | parts |
| Composition | Fe/Co = 70/30 | |
| Hc | 195 kA/m (2450 Oe) | |
| Specific surface area by BET method | 43 | m²/g |
| Crystalline size | 160 | Å |
| Surface treatment agent | Al₂O₃ | |
| Particle size (major axis diameter) | 0.125 | μm |
| Flat acicular particle | | |
| Major axis length (minor axis length)/ | | |
| minor width length = 0.025/0.01 | | |
| σs: 157 (A · m²/kg) emu/g | | |
| Polyester polyurethane resin | 10 | parts |
| Neopentylglycol/caprolactone polyol/MDI | | |
| (4, 4′-diphenylmethane diisocyanate) = 0.9/2.6/1 | | |
| 1 × 10⁻⁴ eq/g-SO₃Na group content | | |
| α-alumina (particle size: 0.18 μm) | 5 | parts |
| Carbon black (particle size: 0.10 μm) | 0.5 | parts |
| Butyl stearate | 1.5 | parts |
| Stearic acid | 0.5 | parts |
| Methyl ethyl ketone | 90 | parts |
| Cyclohexanone | 30 | parts |
| Toluene | 60 | parts |

Each of the above two coating liquids were dispersed using a sand mill after the individual components had been kneaded in a continuous kneader. Polyisocyanate was added to the dispersions obtained; three parts to the coating liquid for the nonmagnetic middle layer, and one part to the coating liquid for the upper magnetic layer. Forty parts of a mixed solvent of methyl ethyl ketone and cyclohexanone was added to each liquid. Each liquid was then filtered using a filter having a mean pore diameter of 1 μm to prepare coating liquids for forming a nonmagnetic layer, an upper magnetic layer, and a lower magnetic layer. Simultaneous multilayer coating on a polyester naphthalate support was conducted by applying the coating liquid for the nonmagnetic layer in a manner yielding the dried thickness of 1.4 μm and applying thereover immediately thereafter the magnetic layer to the thickness of 0.1 μm. The polyester naphthalate support has 0.03 nm² of PSD at a wavelength of 4.3 μm in a roughness spectrum by AFM and 5.2 μm of the thickness. While the two layers were still wet, orientation was imparted with a cobalt magnet having a magnetic force of 300 mT (3000 G) and a solenoid having a magnetic force of 150 mT (1500 G). After drying, a seven-stage calender comprised of only metal rollers was used for processing at 85° C., a pressure of 350 kg/cm, and a speed of 50 m/min, and slits 6.35 mm in width were made to manufacture a popular DVC videotape.

Evaluation Methods

(1) Measurement of Thickness and Particle Shape

A diamond cutter was employed to cut a sample tape to a thickness of about 0.1 μm in a longitudinal direction, which was then observed and photographed at 100,000-fold magnification by a transmission electron microscope (TEM), lines were drawn on the outer surface of the magnetic layer and the interface of the magnetic layer and nonmagnetic layer, and measurements were made with an IBAS2 image processor from Zeiss Co. The length was measured 85 to 300 times over 21 cm and the average value d and standard deviation σ were calculated.

For the shape of the nonmagnetic particles, observation was conducted and photographs were taken at 100,000-fold magnification by a transmission electron microscope (TEM), processing was similarly conducted, and the major axis length, minor axis length, and number of particles in the minor axis direction were determined. From 200 to 300 measurements were taken.

(2) Magnetic Characteristics (Hc, SFD, SQ, Bm, φm): A vibrating sample magnetometer (from Toei Kogyo Co.) was employed to take measurements at an applied magnetic field of Hm 796 A/m. The Bm value was calculated from the above-described average thickness of the magnetic layer and φm.

(3) Ra: A Digital Optical Profiler HD-2000, an optical interference surface roughness meter made by WYKO Co., was employed to take surface measurements with an ×50 object lens and ×0.5 intermediate lens over a measurement range of 242 μm×184 μm. The measurement results were slope and cylinder corrected, yielding basic data. The center-surface average roughness Ra (unit: nm) was calculated from the basic data.

(4) PSD: A fast Fourier transform was conducted on the data obtained by surface measurement with the above-described HD-2000 to determine the relation between wavelength and intensity. In this process, the following value was employed as the intensity: the value obtained by dividing the square of the amplitude for the wavelength by the frequency which is an inverse of that wavelength (referred to hereinafter as the “1D-PSD,” in units of nm³). The 1D-PSD was calculated for wavelengths of 5 μm and 10 μm.

(5) AFM Surface Protrusions: 40 nm↑: A Nanoscope 3 from Digital Instruments Co. was employed to measure the surface roughness at a square of 30 μm using a probe in the form of a rectangular drill of SiN with an rigid of 70 degrees. In this AFM surface roughness measurement, the number of protrusions extending to a height of 40 nm or more above the reference surface was counted.

(6) AFM Surface Protrusions: 20 nm↑: As for 40 nm↑, the number of protrusions extending to a height of 20 nm or more above the reference surface was counted.

(7) DVC 1/2 Tb Output, Total C/N, Medium C/N: The 1/2 Tb C/N was measured with a drum tester. A Bs 1.2 T MIG head with a gap length of 0.22 μm was employed for recording and reproduction. The head velocity relative to the medium during recording and reproduction was 10.5 m/sec A single frequency of 21 MHz was recorded and the reproduction spectrum was measured with a Spectrum Analyzer from Shibasoku. The ratio of 21 MHz carrier output to noise at 18.7 MHz was adopted as the total C/N ratio. The medium C/N ratio was calculated by subtracting amp noise from the above.

TABLE 1
Nonmagnetic Powder

| | | Powder A; | Powder B; | Powder C; |
|---|---|---|---|---|
| | | α-iron | α-iron | α-iron |
| Characteristics of powder | | oxide | oxide | oxide |
| Shape | Particle shape | Acicular | Flat acicular | Clustered tabular |
| | | particle | particle | particle |
| | Section shape of | Circular | Elliptical | |
| | particle | | | |
| | Major axis | 0.15 | 0.125 | 0.17 |
| | length: μm | | | |
| | Minor axis | 0.023 | 0.024 | 0.02 |
| | length: μm | | | |
| | (Major width | | | |
| | length) | | | |
| | Average number | 1 | 1 | 3 |
| | m of particles in | | | |
| | the minor axis | | | |
| | direction | | | |
| | Ratio of major | 1 | 2.4 | (3) |
| | width/minor | | | |
| | width in particle | | | |
| | section | | | |
| | S_{BET} (m²/g) | 53 | 40 | 117 |
| Atomic | Co/Fe | 0 | 29 | 0 |
| compo- | Al/Fe | 5.9 | 5.9 | 5.9 |
| sition | Si/Fe | 0.10 | 0.10 | 0.10 |
| (at %) | Y/Fe | 0 | 8.3 | 0 |
| | Sm/Fe | 0 | 0 | 0 |
| | Mg/Fe | 0 | 0.7 | 0 |
| | Ca/Fe | 0.01 | 0.03 | 0.01 |
| | Na/Fe | 0.01 | 0 | 0.01 |
| Others | pH | 9.0 | 9.1 | 9.1 |

TABLE 2

| | Embodi- | Embodi- | Embodi- | Embodi- | Comp. | Comp. |
|---|---|---|---|---|---|---|
| | ment 1 | ment 2 | ment 3 | ment 4 | Ex. 1 | Ex. 2 |
| Lower layer: main | C | → | → | → | B | A |
| powder: X | | | | | | |
| subpowder: Y | #950B | → | → | → | #950B | #950B |
| X/Y:WT % | 85/15 | → | → | → | 85/15 | 85/15 |
| Thickness of upper | 0.1 | 0.05 | 0.2 | 0.05 | 0.1 | 0.1 |
| magnetic layer d: μ m | | | | | | |
| Thickness of lower | 1.4 | 0.4 | → | 1.4 | 1.4 | 1.4 |
| nonmagnetic layer: μ m | | | | | | |
| Magnetic characteristics | 181 | 178 | 178 | 182 | 181 | 183 |
| of tape: Hc(kA/m) | | | | | | |
| SFD | 0.19 | 0.17 | 0.17 | 0.20 | 0.19 | 0.2 |
| SQ | 0.89 | 0.90 | 0.90 | 0.88 | 0.89 | 0.88 |
| Bm | 6800 | 7200 | 6600 | 6400 | 6800 | 6300 |
| Surface property of | 1.8 | 1.6 | 2.4 | 1.7 | 1.9 | 2.1 |
| magnetic layer: | | | | | | |
| Ra(nm) | | | | | | |
| 1D-PSD: | 2600 | 2200 | 3600 | 2100 | 4000 | 6000 |
| 10 μ m(nm³) | | | | | | |
| 1D-PSD: | 650 | 500 | 800 | 450 | 900 | 1000 |
| 5 μ m(nm³⁾ | | | | | | |
| AFM surface projections: | 0 | 0 | 0 | 0 | 0 | 0 |
| 40 nm ↑ | | | | | | |
| AFM surface projections: | 12 | 26 | 22 | 11 | 12 | 24 |
| 20 nm ↑ | | | | | | |
| DVC ½ Tb output | 0.5 | −6 | 0 | −5 | 0.5 | 0 |
| DVC medium C/N | 2.8 | 4 | 2.2 | 4.5 | 1.6 | 0 |

Determinations were made based on the three evaluation scores given below. Other evaluation items are reference values.

| | | OK Determination |
|---|---|---|
| 1) | 1D-PSD at 5 μm | 850 or less |
| 2) | 1D-PSD at 10 μm | less than 4000 |
| 3) | Medium C/N | 2 dB or greater |

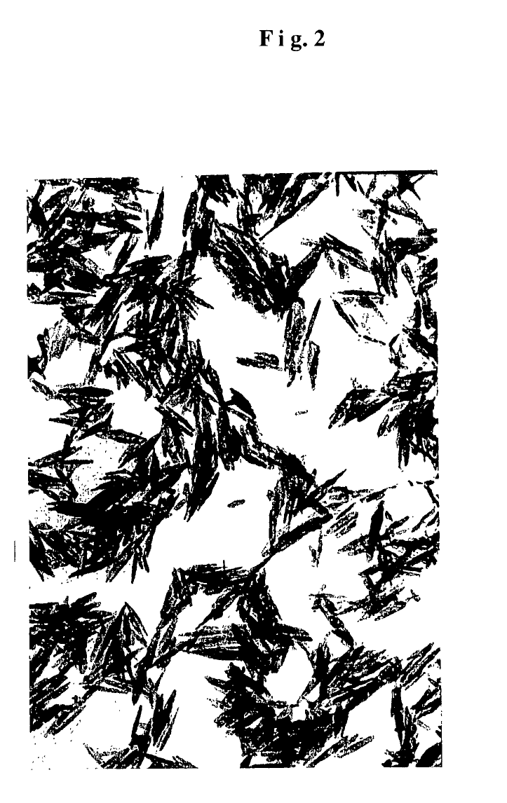

Embodiments 1 to 4 are examples of the incorporation of clustered tabular nonmagnetic powder (powder C, FIG. 1) into the nonmagnetic layer. Comparative Examples 1 and 2 are examples of the incorporation of flat acicular particles (powder B) and acicular particles (powder C, FIG. 2), respectively, in place of clustered tabular nonmagnetic powder. A comparison of Embodiment 1 and Comparative Examples 1 and 2 reveals that in Embodiment 1, the 1D-PSD (10 μm and 5 μm) underwent a greater reduction than in Comparative Examples 1 and 2, resulting in particularly good improvement in the C/N ratio.

Embodiments 2 and 3 are examples of variation in the thickness of the magnetic layer relative to Embodiment 1. In Embodiment 2, with its thin magnetic layer, there is particularly marked improvement in the C/N ratio.

Embodiment 4 is an example of a nonmagnetic layer that is thicker than that in Embodiment 2. Increasing the thickness of the nonmagnetic layer further improved the C/N ratio over Embodiment 2.

According to the present invention, a magnetic recording medium exhibiting high C/N (low noise) in high density magnetic recording can be provided.

The present disclosure relates to the subject matter contained in Japanese Patent Application No. 2001-46641 filed on Feb. 22, 2001, which is expressly incorporated herein by reference in its entirety.

What is claimed is:

1. A magnetic recording medium comprising a nonmagnetic layer comprising a nonmagnetic powder and a binder and a magnetic layer comprising a ferromagnetic powder and a binder on a flexible nonmagnetic support in this order,
wherein said nonmagnetic powder is a clustered tabular nonmagnetic powder having a major axis length ranging from 0.04 to 0.2 μm, a minor axis length equal to or less than 0.04 μm and an acicular ratio equal to or higher than 2 and having a shape in which two or more acicular particles align in almost parallel.

2. The magnetic recording medium of claim 1, wherein said nonmagnetic powder having a shape in which two to five acicular particles align in almost parallel.

3. The magnetic recording medium of claim 1, wherein said minor axis length ranges from 0.005 to 0.03 μm.

4. The magnetic recording medium of claim 1, wherein said acicular ratio ranges from 5 to 10.

5. The magnetic recording medium of claim 1, wherein said nonmagnetic powder is α-iron oxide.

6. The magnetic recording medium of claim 1, wherein said nonmagnetic layer further comprises a granular nonmagnetic powder.

7. The magnetic recording medium of claim 6, wherein said granular nonmagnetic powder is carbon black.

8. The magnetic recording medium of claim 6, wherein the ratio (1x/1y) of the major axis length 1x of the clustered tabular nonmagnetic powder to the mean grain diameter 1y of the granular nonmagnetic powder is equal to or higher than not less than 3.

9. The magnetic recording medium of claim 6, wherein the ratio (K/1y) of the minor axis length K of the clustered tabular nonmagnetic powder to the mean grain diameter 1y of the granular nonmagnetic powder is ranges from 0.3 to −2.

10. The magnetic recording medium of claim 1, wherein said magnetic layer is equal to or less than 0.2 μm in thickness.

11. The magnetic recording medium of claim 1, wherein the ratio of the thickness of magnetic layer to the thickness of nonmagnetic layer (the thickness of magnetic layer/the thickness of nonmagnetic layer) ranges from 0.02 to 0.5.

12. The magnetic recording medium of claim 1, wherein the ratio (d/1x) of the nonmagnetic layer thickness d and the major axis length 1x of the clustered tabular nonmagnetic powder ranges from 0.05 to 25.

13. The magnetic recording medium of claim 6, wherein the content of clustered tabular nonmagnetic powder ranges from 10- to 100 weight parts per 100 weight parts of the total nonmagnetic powder contained in the nonmagnetic layer.
